(19) United States
(12) Patent Application Publication
(10) Pub. No.: US 2020/0258196 A1
(43) Pub. Date: Aug. 13, 2020

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Toru Kokura, Kawasaki-shi (JP)

(21) Appl. No.: 16/750,520

(22) Filed: Jan. 23, 2020

(30) Foreign Application Priority Data
Feb. 8, 2019 (JP) 2019-021687

(51) Int. Cl. G06T 3/40; G06N 3/04; G06T 5/50

(52) U.S. Cl. CPC G06T 3/4076; G06N 3/04; G06T 2207/20084; G06T 2207/10028; G06T 2207/20081; G06T 5/50

(57) ABSTRACT

An image processing apparatus 106 obtains a captured image captured by an image capturing device 102 in an input image obtaining unit 501. A foreground background separating unit 503 obtains a foreground input image 302 by separating a foreground area including a specific object from the obtained captured image. By inputting the foreground input image 302 to a resolution enhancing unit 506, a foreground output image 306 having a higher resolution as compared to the foreground input image 302 is outputted from the resolution enhancing unit 506. The foreground output image 306 is used to generate a virtual viewpoint image.

### BACKGROUND

### Field

The present disclosure relates to an image processing technology using machine learning.

### Description of the Related Art

There is known a method using a convolutional neural network as a technology to form a high-resolution image from a low-resolution image (Dong Chao, et al. “Learning a deep convolutional network for image super-resolution.” European Conference on Computer Vision, 2014 (hereinafter referred to as NPL 1)). This processing is divided into the following two stages. In a first stage (learning stage), a plurality of sets having a high-resolution teacher image and a low-resolution image with a low resolution corresponding to the high-resolution teacher image are prepared, and learning is performed on a processing device configured to convert the low-resolution image into the teacher image. In a second stage (application stage), a low-resolution input image which is different from the one used in learning is inputted to the processing device on which learning has been performed, whereby a high-resolution image corresponding to the input image is outputted.

On an input image, there may appear not only an object as a subject, but also various matters such as a floor, a wall, a structure, or a human figure different from the subject. In other words, there is a problem that even in a case where input images include the same object as a subject, because of the influence of other matters reflected on the input images, blurs or artifacts may occur in output images.

### SUMMARY

According to one aspect of the present disclosure, there is provided an image processing apparatus including: an obtaining unit configured to obtain a first input image including a first area representing a specific object in a captured image obtained by capturing by an image capturing device; and an outputting unit configured to output a first output image having a higher resolution as compared to the first input image by inputting the first input image obtained by the obtaining unit, the first output image being used to generate a virtual viewpoint image.

Further features of the present disclosure will become apparent from the following description of exemplary embodiments with reference to the attached drawings.

### BRIEF DESCRIPTION OF THE DRAWINGS

FIG. 1 is a schematic view of an image capturing system;

FIG. 2 is a block diagram showing a hardware configuration of an image processing apparatus;

FIG. 3 is a diagram illustrating an outline of resolution enhancing processing;

FIG. 4 is a diagram illustrating decrease in resolution enhancing accuracy;

FIG. 5 is a block diagram showing a functional configuration of the image processing apparatus;

FIG. 6A and FIG. 6B are flowcharts showing a flow of resolution enhancing processing;

FIG. 7 is a diagram illustrating an example in which an artifact occurs in integration;

FIG. 8 is a block diagram showing a functional configuration of an image processing apparatus;

FIG. 9 is a flowchart showing a flow of resolution enhancing processing;

FIG. 10 is a diagram representing a situation in which there are a large number of singular pixels;

FIG. 11 is a diagram illustrating an outline of resolution enhancing processing;

FIG. 12 is a block diagram showing a functional configuration of an image processing apparatus;

FIG. 13A and FIG. 13B are flowcharts showing a flow of resolution enhancing processing;

FIG. 14A and FIG. 14B are flowcharts showing a flow of resolution enhancing processing; and

FIG. 15 is a block diagram showing a functional configuration of an image processing apparatus.

### DESCRIPTION OF THE EMBODIMENTS

Embodiments of the present disclosure will be described with reference to the drawings. It should be noted that the following embodiments will not limit the present disclosure, and all of the combinations of the features described in the present embodiments will not be always essential for solution of the present disclosure. Incidentally, the same component is denoted by the same reference numeral in the following description.

### First Embodiment

### <Entire Configuration of Image Capturing System>

In a first embodiment, an example of an image processing apparatus that performs resolution enhancing process (also, refereed as high resolution process) based on learning will be described. In a learning stage, learning is performed based on a high-resolution image obtained by capturing a face of an athlete which is an object as a subject. Then, in an application stage, resolution enhancing process (high resolution process) of a low-resolution input image is performed. It should be noted that the terms “low-resolution” and “high-resolution” described in the present embodiment represent an example of a relative relationship between resolutions. For this reason, it should be understood that a predetermined resolution (e.g., 300 dpi) may have a value for low resolution or a value for high resolution. In other words, it can be said that the resolution enhancing processing is processing to convert an input image with a first resolution into an output image with a second resolution which is higher than the first resolution.

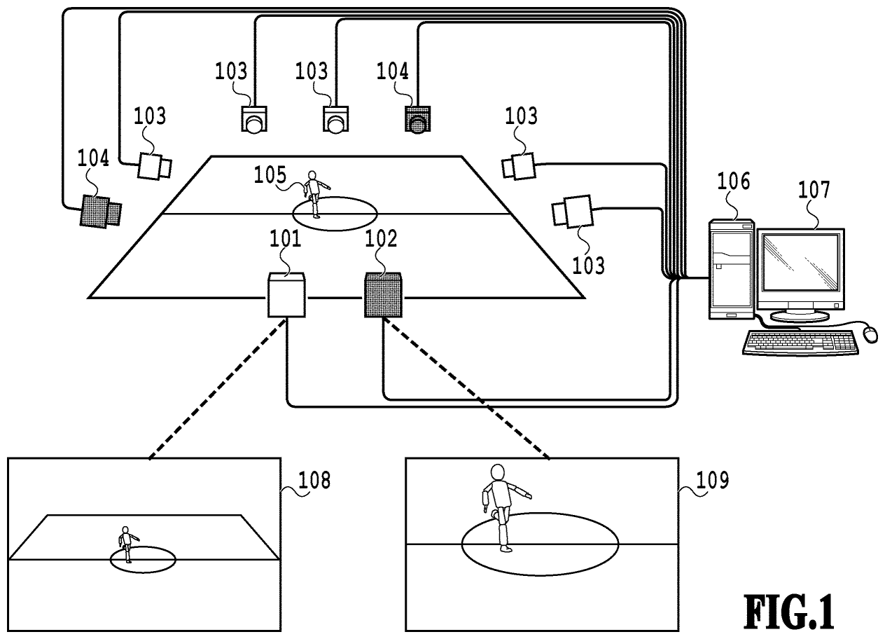

FIG. 1 is a schematic view showing an example of an image capturing system according to the present embodiment. In a stadium, an image capturing device 101 is provided. A whole body including a face of an athlete 105 is captured by using the image capturing device 101, and an image 108 is obtained. An image capturing device 102 captures an image to be used to enhance resolution of the obtained image 108. The image capturing device 102 has a lens having a longer focal length as compared to the image capturing device 101, and an image 109 is obtained by capturing the object (athlete 105) with a high resolution while having a narrower angle of view as compared to the image 108. The image capturing system includes an image processing apparatus 106 for enhancing resolution of an image and a display device 107. Note that the image capturing system may also include one or more image capturing devices 103 that capture an object with a low resolution like the image capturing device 101 and image capturing devices 104 that capture an object with a high resolution like the image capturing device 102. Furthermore, a sports scene has been described as an example in FIG. 1, but the present embodiment is also applicable to a typical scene that captures an object with different resolutions. The present embodiment is also applicable to an image in which an object as a subject is other than a face.

### <Hardware Configuration of Image Processing Apparatus>

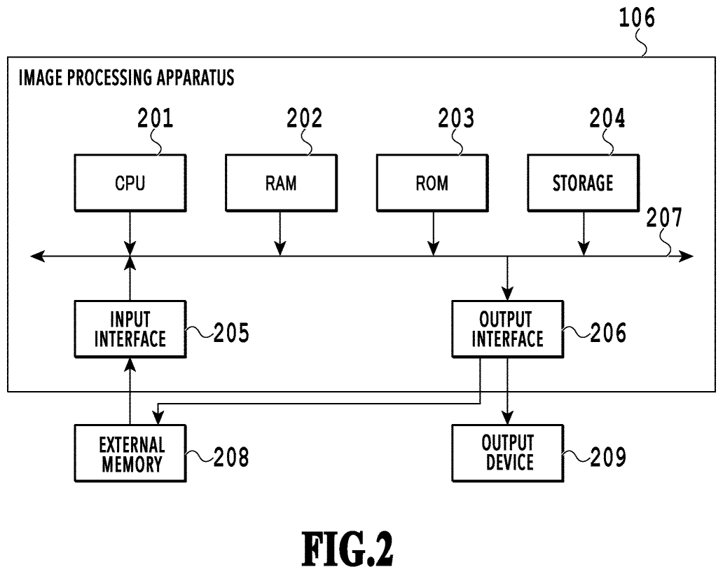

FIG. 2 is a diagram showing a configuration of the image processing apparatus 106 according to the present embodiment. The image processing apparatus 106 includes a CPU 201, a RAM 202, a ROM 203, a storage 204, an input interface 205, an output interface 206, and a system bus 207. An external memory 208 is connected to the input interface 205 and the output interface 206, and an output device 209 is connected to the output interface 206.

The CPU 201 is a processor that has control over the components of the image processing apparatus 106. The RAM 202 is a memory that functions as a main memory and a work area of the CPU 201. The ROM 203 is a memory that stores programs and the like used for processing in the image processing apparatus 106. The CPU 201 uses the RAM 202 as a work area and executes the programs stored in the ROM 203, thereby executing various kinds of processing as described later. The storage 204 is a storage device that stores image data to be used for processing, parameters for the processing, and the like in the image processing apparatus 106. For the storage 204, a HDD, an optical disk drive, a flash memory, and the like may be used.

It should be noted that the image processing apparatus 106 may have one or more pieces of dedicated hardware or a GPU (graphics processing unit) different from the CPU 201. At least part of the processing by the CPU 201 may be performed by the GPU or the dedicated hardware. Examples of the dedicated hardware include an ASIC (application-specific integrated circuit), a DSP (digital signal processor), and the like.

The input interface 205 is, for example, a serial bus interface such as a USB or IEEE1394. The image processing apparatus 106 can obtain, via the input interface 205, image data or the like to be processed from the external memory 208 (e.g., a hard disk, a memory card, a CF card, an SD card, a USB memory). The output interface 206 is, for example, a video output terminal such as a DVI, an HDMI (registered trademark), and the like. The image processing apparatus 106 can output, via the output interface 206, the image data processed by the image processing apparatus 106 to the output device 209 (an image display device such as a liquid crystal display). Incidentally, the image processing apparatus 106 may include a component other than the above-described components, but description thereof is omitted herein.

### <Outline of Resolution Enhancing Processing>

In the present embodiment, an object as a subject in an image is referred to as a “foreground,” and a matter other than the foreground is referred to as a “background.” For example, the foreground is an area including a face of a human figure. This area may include an area in the vicinity of the face, such as part of an upper body of the human figure. The background is a matter other than the foreground and includes, for example a floor, a wall, or a structure. Furthermore, the background may include a face of a human figure different from the object as a subject.

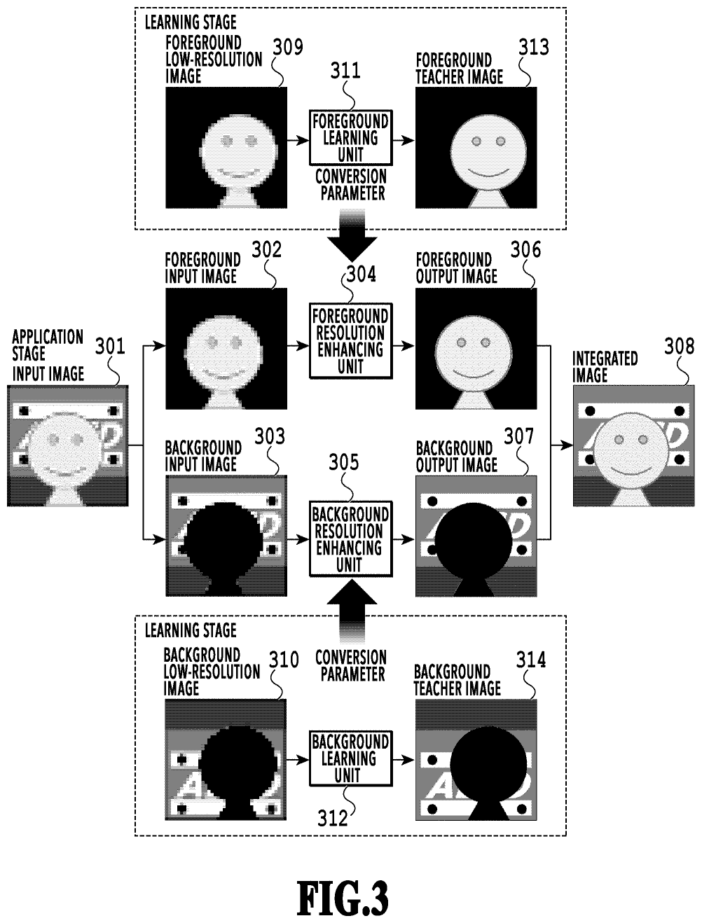

FIG. 3 is a diagram illustrating an outline of resolution enhancing processing according to the present embodiment. In the present embodiment, the image processing apparatus 106 separates (divides) an input image into a foreground part and a background part. Then, an image of a foreground part and an image of a background part are resolution-enhanced individually. To individually enhance resolution of the foreground part and the background part in this manner, in the learning stage, the image processing apparatus 106 learns a conversion parameter used for the resolution enhancing process of the foreground part and a conversion parameter used for the resolution enhancing process of the background part, individually. Hereinafter, the resolution enhancing processing will be described with reference to FIG. 3.

First, in the learning stage, a set of a foreground low-resolution image 309 and a foreground teacher image 313 which is a high-resolution image corresponding to the foreground low-resolution image 309 is inputted to a foreground learning unit 311. The foreground learning unit 311 learns from the set as an input and obtains a conversion parameter for a function of conversion from the foreground low-resolution image 309 into the foreground teacher image 313. Likewise, a set of a background low-resolution image 310 and a background teacher image 314 which is a high-resolution image corresponding to the background low-resolution image 310 is inputted to a background learning unit 312. The background learning unit 312 learns from the set as an input and obtains a conversion parameter for a function of conversion from the background low-resolution image 310 into the background teacher image 314. Note that details of the foreground learning unit 311 and the background learning unit 312 will be described later.

Next, in the application stage, the image processing apparatus 106 receives an input image 301 with a low resolution and separates the input image 301 into a foreground input image 302 corresponding to a foreground and a background input image 303 corresponding to a background. In the image processing apparatus 106, the foreground input image 302 is inputted to a foreground resolution enhancing unit 304 which is a neural network that enhances resolution of the foreground. Furthermore, the background input image 303 is inputted to a background resolution enhancing unit 305 which is a neural network that enhances resolution of the background. In the foreground resolution enhancing unit 304, conversion is performed by using a conversion parameter learned in the foreground learning unit 311. In the background resolution enhancing unit 305, conversion is performed by using a conversion parameter learned in the background learning unit 312. The foreground resolution enhancing unit 304 outputs a foreground output image 306 on which resolution enhancing has been performed and the background resolution enhancing unit 305 outputs a background output image 307 on which resolution enhancing has been performed. The image processing apparatus 106 integrates the foreground output image 306 and the background output image 307 and obtains an integrated image 308 on which resolution enhancing has been performed.

According to this processing, even in a case where an input image including the same object (foreground) as a subject but not being similar to a teacher image due to the influence of other matters reflected on the input image is inputted, it is possible to obtain a high-resolution image in which occurrence of blurs or artifacts is inhibited. In other words, it is possible to obtain a high-resolution image in which occurrence of image defects, such as occurrence of a low-resolution portion in an image or occurrence of a portion unlike a natural image, is inhibited.

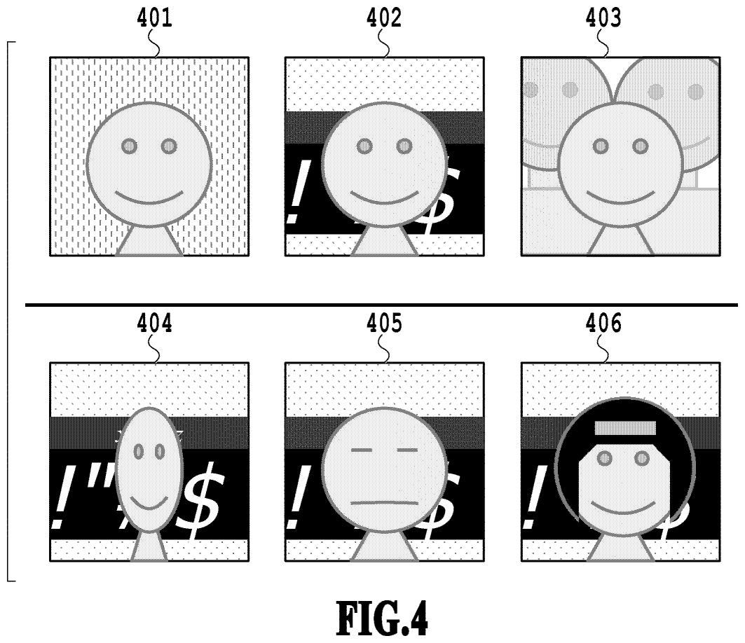

FIG. 4 is a diagram illustrating occurrence of blurs or artifacts. An image 401 to an image 403 show an example in which an object (foreground) as a subject is the same human figure but backgrounds of the images greatly differ from each other. In a stadium used for sports such as soccer or rugby, an image including a background of lawn like the image 401 is often obtained. Meanwhile, like the image 402, an image including a background of the ground other than the lawn, such as a signboard or a floor with characters having thereon, may also be obtained. Furthermore, like the image 403, a different human figure may appear on the background. In the method disclosed in NPL 1, an image not similar to the image used in the learning stage may have blurs or artifacts in the application stage. For instance, in a case where learning is performed using an image including a background of lawn like the image 401, if the image 402 or the image 403 is used as input data in the application stage, an image having a background not similar to that of the learned image becomes an input image, and blurs or artifacts may occur.

Meanwhile, an image 404 to an image 406 show an example in which images have the same whole composition including a background but have an object (foreground) as a subject that greatly differs depending on the image. Images may have differences, such as a case where a foreground shape may vary depending on an image capturing direction like the image 404, a case where a facial expression is different like the image 405, or a case where an outline is hiding due to equipment such as a helmet like the image 406. In these cases, if an image having a foreground not similar to that of the image used in the learning stage becomes an input image, blurs or artifacts may occur in an image on which resolution enhancing processing has been performed.

As described above, depending on the image, a difference may exist in a background or a difference may exist in a foreground. In the present embodiment, in both of the learning stage and the application stage, an input image is separated into an image representing a foreground area (a foreground teacher image or a foreground input image) and an image representing a background area (a background teacher image or a background input image). In the learning stage, learning with use of a foreground teacher image and learning with use of a background teacher image are performed individually. In the application stage, a foreground input image is resolution-enhanced by using the foreground resolution enhancing unit generated by the learning with use of a foreground teacher image, and a background input image is resolution-enhanced by using the background resolution enhancing unit generated by the learning with use of a background teacher image. Then, by integrating a foreground output image and a background output image on which resolution enhancing has been performed, an integrated image on which resolution enhancing has been performed is obtained. According to this processing, in both of the case where a difference exists in a foreground and the case where a difference exists in a background, it is possible to achieve resolution enhancing while inhibiting occurrence of blurs or artifacts.

### <Configuration of Image Processing Apparatus and Processing Flow>

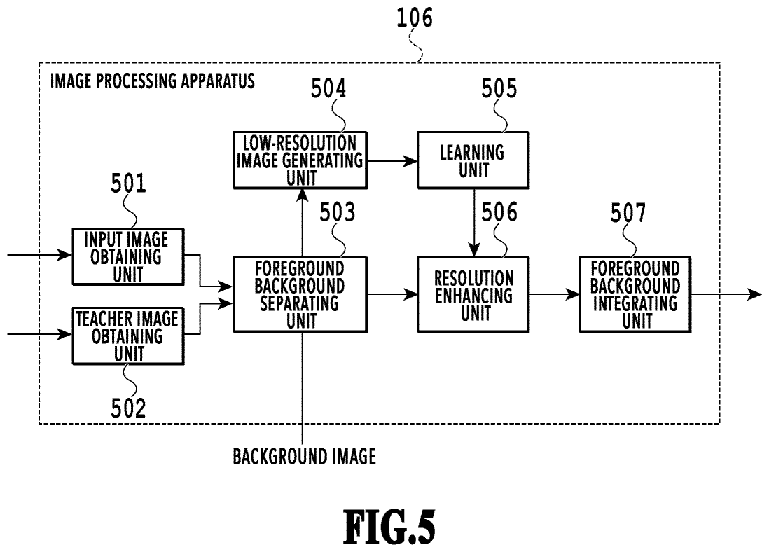

FIG. 5 is a block diagram showing a functional configuration of the image processing apparatus 106 according to the present embodiment. The image processing apparatus 106 includes an input image obtaining unit 501, a teacher image obtaining unit 502, a foreground background separating unit 503, a low-resolution image generating unit 504, a learning unit 505, a resolution enhancing unit 506, and a foreground background integrating unit 507. The foreground learning unit 311 and the background learning unit 312 shown in FIG. 3 are included in the learning unit 505. Furthermore, the foreground resolution enhancing unit 304 and the background resolution enhancing unit 305 shown in FIG. 3 are included in the resolution enhancing unit 506. The image processing apparatus 106 functions as the components shown in FIG. 5 by the CPU 201 that executes the programs stored in the ROM 203 by using the RAM 202 as a work memory.

It should be noted that in the present embodiment, an aspect in which the processing in the learning stage and the processing in the application stage are performed in the same image processing apparatus 106 will be described as an example, but the present embodiment is not limited to this. The image processing system may have a first apparatus that performs the processing in the learning stage and a second apparatus that performs the processing in the application stage. In this case, the first apparatus may include components corresponding to the teacher image obtaining unit 502, the foreground background separating unit 503, the low-resolution image generating unit 504, and the learning unit 505. The second apparatus may include components corresponding to the input image obtaining unit 501, the foreground background separating unit 503, the resolution enhancing unit 506, and the foreground background integrating unit 507. Then, the image processing system only needs to have a configuration that a conversion parameter that has already been learned is provided by the first apparatus to the second apparatus.

The foreground learning unit 311 may be configured to have a neural network structure and capable of performing resolution enhancing processing on an input image by adjusting various parameters based on learning. In other words, the foreground learning unit 311 on which learning has been performed may be configured to function as the foreground resolution enhancing unit 304. Likewise, the background learning unit 312 may be configured to have a neural network structure and capable of performing resolution enhancing processing on an input image by adjusting various parameters based on learning. The background learning unit 312 on which learning has been performed may be configured to function as the background resolution enhancing unit 305. That is, the resolution enhancing unit 506 may function as a processing unit generated by the learning of the learning unit 505.

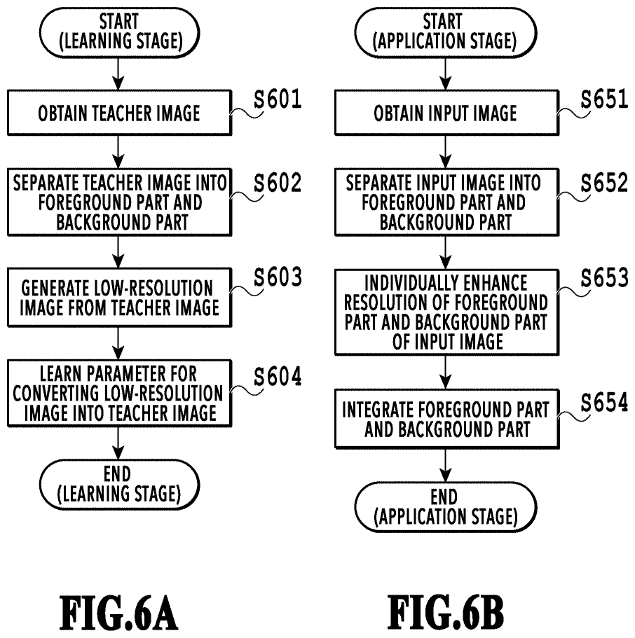

FIG. 6A and FIG. 6B are flowcharts showing an example of the processing in the image processing apparatus 106 according to the present embodiment. FIG. 6A shows the processing in the learning stage. FIG. 6B shows the processing in the application stage. Processing of the components in the image processing apparatus 106 will be described with reference to the block diagram of FIG. 5 and the flowcharts of FIG. 6A and FIG. 6B. The series of processing shown in the flowcharts of FIG. 6A and FIG. 6B are performed by the CPU 201 that loads a program code stored in the ROM 203 into the RAM 202 and executes it. Alternatively, part of the steps in FIG. 6A and FIG. 6B or all of the functions may be achieved by hardware such as an ASIC or an electronic circuit. It should be noted that the sign “S” in the description of each processing means a step in the flowchart.

### <Processing in Learning Stage>

In S601, the teacher image obtaining unit 502 obtains image data on an image from the image capturing device 102 that captures an image of a subject with a high resolution or from the storage 204. In the present embodiment, an image obtained in S601 is a rectangular image having a face of an athlete. Like the image 109 in FIG. 1, in a case where an image having a large area other than the athlete is captured, the teacher image obtaining unit 502 may obtain the image in S601 by cutting out a face portion of the athlete to generate an image. The obtained image is outputted to the foreground background separating unit 503.

In S602, the foreground background separating unit 503 separates the image outputted from the teacher image obtaining unit 502 into a foreground part and a background part. In other words, the foreground background separating unit 503 generates the foreground teacher image 313 and the background teacher image 314 as shown in FIG. 3 from the image outputted from the teacher image obtaining unit 502. In the foreground teacher image 313, a portion including a background before separation is filled with a pixel having a luminance value of 0, namely, a black pixel. Meanwhile, in the background teacher image 314, a portion including a foreground before separation is filled with a pixel having a luminance value of 0, namely, a black pixel. Incidentally, as long as the portion including a foreground before separation and the portion including a background before separation can be distinguished from each other, a luminance value does not need to be 0.

The processing of separating a foreground from a background part is called foreground background separation processing. The foreground background separation processing is processing to estimate and determine a foreground area and is typically performed by using a background subtraction method. The background subtraction method is a method for separating a moving object from a still object based on observation results at different times in the same field of view. For instance, a difference between a background image and an input image including a foreground is calculated, and an area of a group of pixels determined to have a difference value equal to or greater than a predetermined threshold is regarded as a foreground area. In estimation processing of the foreground area, a difference is typically calculated by using a characteristic amount of an image such as luminance, color, or texture. In the present embodiment, it is assumed that the foreground background separating unit 503 is externally provided with a background image obtained based on observation results at different times in the same field of view. By using the background image, the foreground background separating unit 503 performs separation based on an assumption that, in the teacher image, a part matching the background image is regarded as a background and a part not matching the background image is regarded as a foreground. It should be noted that the foreground background separation processing is not limited to this example. The foreground background separating unit 503 may perform separation between the foreground and the background by graph cut. Furthermore, an area in which a motion vector calculated by an optical flow calculation method is different from the surrounding may be regarded as a foreground. Furthermore, an area in which a distance calculated by a depth estimation method is smaller as compared to the surrounding may be regarded as a foreground. As long as an image can be separated into a foreground area and a background area which is an area other than the foreground area, any method can be used. The foreground teacher image and the background teacher image generated by the foreground background separating unit 503 are outputted to the low-resolution image generating unit 504.

In S603, the low-resolution image generating unit 504 generates the foreground low-resolution image 309 by reducing resolution of the foreground teacher image outputted from the foreground background separating unit 503. Furthermore, the low-resolution image generating unit 504 generates the background low-resolution image 310 by reducing resolution of the background teacher image. For reducing resolution, an area-average method may be used for scaling down an image by taking an average of pixel values of a plurality of pixels in the teacher image as a pixel value of one pixel corresponding to the plurality of pixels in the low-resolution image. It should be noted that an image may be scaled down based on interpolation such as a bicubic method. Reducing resolution may also be performed by using a filter for reducing a high-frequency component. Reducing resolution may also be performed based on a method for reproducing a process for capturing a teacher image with a short focal length.

It should be noted that in the present embodiment, an example is shown in which the teacher image is separated into the foreground teacher image and the background teacher image, and low-resolution images are generated respectively from the foreground teacher image and the background teacher image after separation, but the present embodiment is not limited to this. A teacher image may be outputted from the teacher image obtaining unit 502 to the low-resolution image generating unit 504; a low-resolution image obtained by reducing resolution of the teacher image by the low-resolution image generating unit 504 may be generated; and the generated low-resolution image may be outputted to the foreground background separating unit 503. Then, the foreground background separating unit 503 may separate the low-resolution image outputted from the low-resolution image generating unit 504 into the foreground low-resolution image and the background low-resolution image. Furthermore, the low-resolution image may be obtained from the storage 204 or from the image capturing device that captures an image of a subject with a low resolution. The thus-obtained foreground low-resolution image, background low-resolution image, foreground teacher image, and background teacher image are outputted to the learning unit 505.

In S604, the learning unit 505 inputs the received images to input layers on the neural network of the learning unit 505 and learns. First, the foreground low-resolution image is inputted to a foreground neural network (the foreground learning unit 311); a neural network parameter (a foreground conversion parameter) is adjusted such that the foreground low-resolution image is converted into the foreground teacher image; and a foreground conversion parameter is obtained. Second, the background low-resolution image is inputted to a background neural network (the background learning unit 312); a neural network parameter (a background conversion parameter) is adjusted such that the background low-resolution image is converted into the background teacher image; and a background conversion parameter is obtained. The neural network as used herein is a resolution enhancing network disclosed in NPL 1. As the resolution enhancing network, a generative adversarial network (GAN) may also be used. In the generative adversarial network, processing is typically performed by using two networks: Generator and Discriminator. The Generator learns to generate a “fake” which strongly resembles an original so as not to be detected by the Discriminator. The Discriminator determines whether the inputted one is the “fake” generated by the Generator or the original (“real”), and learns to detect the “fake” generated by the Generator. The two networks learn through so-called friendly rivalry, which allows the Generator to increase learning accuracy.

The foreground conversion parameter and the background conversion parameter obtained by the learning unit 505 are outputted to the resolution enhancing unit 506. The processing in the learning stage has been described. The conversion parameters are optimized by repeating the inputting of the teacher image and the learning. In other words, the processing shown in FIG. 6A is repeated for learning.

### <Processing in Application Stage>

Next, a flow of the processing in the application stage will be described. It should be noted that the processing in the application stage does not need to be performed immediately after the learning stage. A predetermined period may exist between the application stage and the learning stage.

In S651, the input image obtaining unit 501 obtains an input image from the image capturing device 101 that captures an image of a subject with a low resolution or from the storage 204. The input image is a rectangular image having a face of an athlete. Like the teacher image, the input image obtaining unit 501 may obtain the image by appropriately cutting out a face portion of the athlete to generate the image. The obtained input image is outputted to the foreground background separating unit 503.

In S652, the foreground background separating unit 503 separates the input image 301 into a foreground part and a background part by the same processing as S602. The foreground input image 302 and the background input image 303 obtained by separation are outputted to the resolution enhancing unit 506.

In S653, the resolution enhancing unit 506 obtains a foreground input image and a background input image from the foreground background separating unit 503. The resolution enhancing unit 506 has obtained a foreground conversion parameter and a background conversion parameter from the learning unit 505. The resolution enhancing unit 506 has the foreground resolution enhancing unit 304 and the background resolution enhancing unit 305 shown in FIG. 3. They are the neural networks having the same layer structure as that used in the learning unit 505. The resolution enhancing unit 506 substitutes the foreground conversion parameter into the foreground neural network (the foreground resolution enhancing unit 304) and inputs the foreground input image 302, thereby obtaining the foreground output image 306 on which resolution enhancing has been performed as its output. Likewise, the resolution enhancing unit 506 inputs the background input image 303 to the background neural network (the background resolution enhancing unit 305), and obtains the high-resolution background output image 307 as its output. The foreground output image 306 and the background output image 307 are outputted to the foreground background integrating unit 507.

In S654, the foreground background integrating unit 507 integrates the foreground output image 306 and the background output image 307 outputted from the resolution enhancing unit 506 and generates the integrated image 308 corresponding to one image including a foreground part and a background part. The integrated image 308 is determined as a sum for each pixel in the foreground output image 306 and the background output image 307 as expressed by the following expression (1):

s_{x,y,c}=f_{x,y,c}+b_{x,y,c} Expression (1).

Now, s_{x,y,c} indicates a value of a channel c of a pixel in the coordinate position (x, y) in the integrated image. f_{x,y,c} indicates a value of a channel c of a pixel in the coordinate position (x, y) in the foreground output image. b_{x,y,c} indicates a value of a channel c of a pixel in the coordinate position (x, y) in the background output image. Note that the value of s_{x,y,c} may also be determined, for example, as a weighted sum or a maximum value of both f_{x,y,c,} and b_{x,y,c,} by using another integration method.

It should be noted that depending on uses, the foreground output image 306 and the background output image 307 do not need to be integrated.

As described above, according to the present embodiment, in the learning stage, an image is separated into the teacher image of the foreground part and the teacher image of the background part, and the foreground and the background are learned individually. Furthermore, also in the application stage, an input image is separated into the input image of the foreground part and the input image of the background part, and the foreground and the background are resolution-enhanced individually. According to this processing, even in a case where an input image which is not similar to a teacher image due to the influence of other matters reflected on the input image is inputted, it is possible to inhibit decrease in resolution enhancing accuracy.

Although the example of separating the image into the foreground and the background has been described above, separation may be performed based on a different basis. For example, in enhancing resolution of a scenic image, the image may be separated into the ground and the sky. In enhancing resolution of a document image, the image may be separated into characters and a paper surface.

Furthermore, an image may be separated into three or more areas. For example, an image may be separated into an area of a human figure, an area of the ground (e.g., lawn and pavement), and an area of a structure (e.g., pole and pillar). In addition, the area of the human figure may further be separated into segments, such as a head portion, clothes, and limbs. In any case, learning and resolution enhancing may be performed for each separated area, and resolution enhancing results may be integrated.

Although the example of using an image capturing device having a long focal length to obtain a high-resolution teacher image has been described above, an image capturing device having a large number of pixels may be used. Furthermore, since a subject appearing in the front of a screen, if focused, is captured with a higher resolution as compared to the subject appearing in the back of a screen, an image of the subject appearing in the front of the screen of the image capturing device 101 may be used as a teacher image.

Incidentally, the technology described in the present embodiment may be applied not only to sports but also to a concert or the like.

### Second Embodiment

In a case where resolution enhancing is performed by using the processing described in the first embodiment, artifacts may occur in the vicinity of a boundary between a foreground and a background in integration.

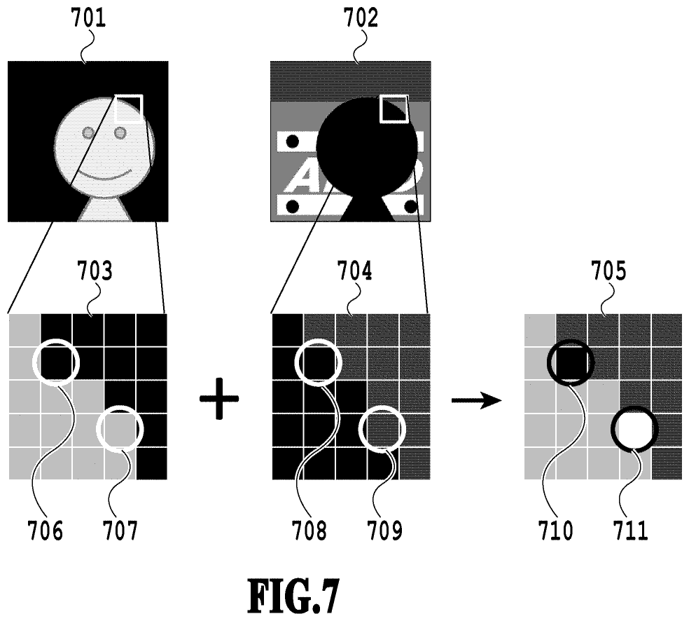

FIG. 7 is a diagram illustrating an example in which an artifact occurs in integration. An image 703 and an image 704 are enlarged schematic diagrams of the same area in the vicinity of the outline in a foreground output image 701 and a background output image 702, respectively. An integrated image 705 is an image obtained by integrating the image 703 and the image 704. In the image 703, a pixel 706 is a pixel having a low luminance on the foreground output image 701 (namely, a pixel estimated to be the background). In the image 704, a pixel 708 is a pixel having a low luminance on the background output image 702 (namely, a pixel estimated to be the foreground). In integrating these images, assuming that a luminance value of the integrated image is the sum of luminance values of both images, a luminance value of an pixel 710 represented by the sum of the luminance value of the pixel 706 and the luminance value of the pixel 708 becomes prominently low as compared to the surrounding. The prominent pixel is referred to as a singular pixel.

Likewise, in a case of integrating a pixel 707 having a high luminance on the foreground output image 701 (namely, a pixel estimated to be the foreground) and a pixel 709 having a high luminance on the background output image 702 (namely, a pixel estimated to be the background), a singular pixel 711 which has a prominently high luminance value is generated. For simplicity, an image having only a luminance channel is mentioned herein, but a singular pixel may occur also in an image having multiple channels like an RGB image.

In the present embodiment, such a singular pixel is detected among the integrated image, and a pixel value of the singular pixel is corrected by using pixels around the singular pixel, so as to cope with an artifact. Such an aspect will be described.

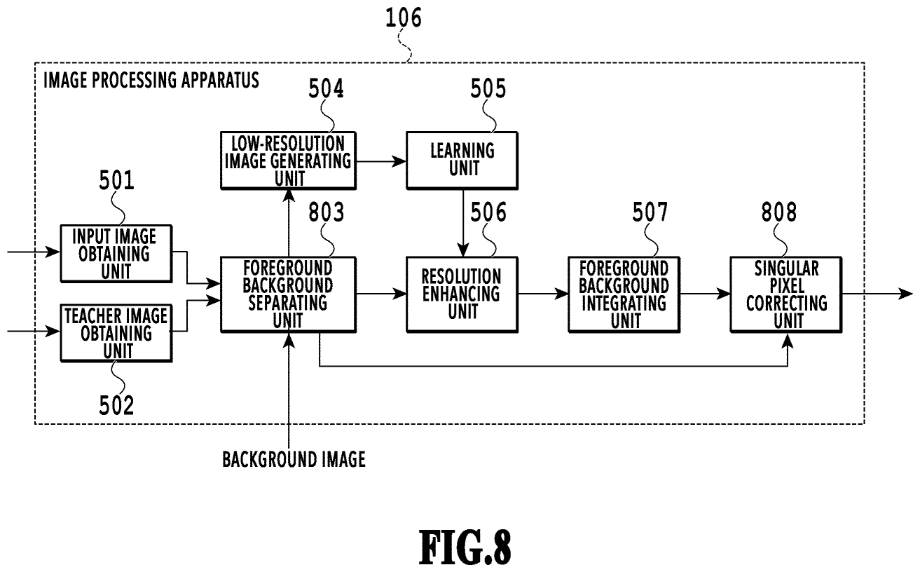

FIG. 8 is a block diagram showing a functional configuration of the image processing apparatus 106 according to the present embodiment. The same component as the one shown in FIG. 5 described in the first embodiment will be denoted by the same reference numeral, and the description thereof will be omitted. The image processing apparatus 106 according to the present embodiment further has a singular pixel correcting unit 808, in addition to the components described in the first embodiment. A foreground background separating unit 803 is configured to output data on a mask image to the singular pixel correcting unit 808, in addition to the processing described in the first embodiment. The singular pixel correcting unit 808 corrects the integrated image as integrated by the foreground background integrating unit 507 by using the mask image and outputs an integrated image as corrected.

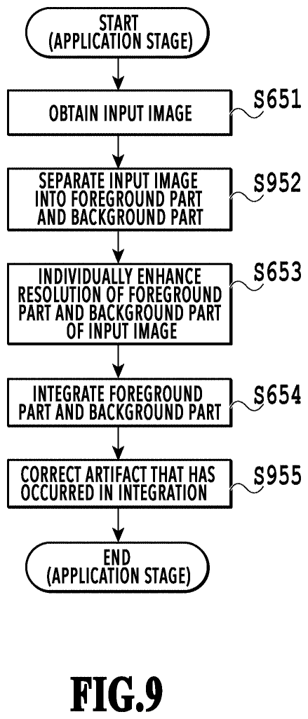

FIG. 9 shows an example of a flowchart according to the present embodiment. The same processing as the processing shown in FIG. 6A and FIG. 6B is denoted by the same reference numeral, and the description thereof will be omitted. In the present embodiment, the processing in the learning stage is the same as that in the first embodiment, and the description thereof will be omitted.

The processing in S651 in the application stage is the same as that in the first embodiment. Then, in S952, the foreground background separating unit 803 performs processing of separating an input image outputted from the input image obtaining unit 501 into a foreground part and a background part as described in the first embodiment. At this time, in the present embodiment, the foreground background separating unit 803 generates a mask image which is an image of a foreground part having a luminance value of 1 and a background part having a luminance value of 0 and outputs it to the singular pixel correcting unit 808. Then, after the resolution enhancing processing in S653, an integrated image is outputted in S654 like the first embodiment. Then, the processing proceeds to S955.

In S955, the singular pixel correcting unit 808 detects a singular pixel like a pixel 710 or a pixel 711 shown in FIG. 7. Then, with reference to pixel values around the detected singular pixel, a value of the singular pixel is corrected. In the present embodiment, as for any coordinates (u, v) on the integrated image, the pixel in the coordinates is handled as a singular pixel if the following two conditions are satisfied: (A) a distance from a boundary between a foreground and a background is equal to or smaller than a certain value; and (B) a difference in a pixel value from the surrounding is equal to or greater than a certain value. In other words, the singular pixel correcting unit 808 detects the pixel satisfying the above two conditions as a singular pixel. Incidentally, the proximity to the boundary may be calculated with reference to the mask image outputted from the foreground background separating unit 503. For example, the proximity to the boundary may be calculated as a distance from a pixel in the closest proximity among the pixels serving to switch between the foreground and the background. Furthermore, the above condition (B) is assumed to be true in a case of satisfying the following expression (2):

∃c, s.t.|s_{u,v,c}−M[N(u, v, c)]|>θ Expression (2).

Now, θ is a predefined threshold. M[⋅] represents a statistic in parentheses and indicates a median in the present embodiment. N is an adjacency set. The adjacency set N represents a set of pixel values of pixels close to the coordinates (u, v). For example, the expression (2) indicates that in one of channels c, a difference between a value of the channel c in the coordinates (u, v) on an integrated image s and a median of the channel c of the pixels close to the coordinates (u, v) may exceed a threshold value θ. Now, the adjacency set N may be written with the following expression (3):

N(u,v,c)={s_{i,j,c}|0<∥\vec{u}−\vec{i}∥ₚ<θ_{dist}} Expression (3),

where

\vec{u}=(u,v), \vec{i}=(i,j)

### Furthermore,

∥⋅∥ₚ
   is a p-norm, where p=2, or p=1 or p=˜. Moreover, θ_{dist} is a parameter representing an area of a search range.

A value of the detected singular pixel is corrected as a median of values of surrounding pixels as the following expression (4):

s_{u,v,c}←M[N(u,v,c)] Expression (4).

It should be noted that M[⋅] may also be a most frequent value/an average in parentheses. The adjacency set N may also include a pixel value of the related portion in the input image. In a case where images at a plurality of times are resolution-enhanced, the adjacency set N may include the pixel values of the resolution enhancing results at preceding and succeeding times. A singular pixel may also be corrected by using an inpainting method.

It should be noted that in the present embodiment, description has been given of the example of the aspect of separating the image into the foreground and the background and correcting the singular pixel in the boundary part between the foreground and the background, but the present embodiment is not limited to this. As long as the singular pixel that could appear in the boundary part of the separated object in separating the image is corrected, any aspect may be employed.

According to the above-described present embodiment, it is possible to inhibit an artifact that may occur in the boundary part by detecting and correcting the singular pixel appearing in the separated boundary part.

### Third Embodiment

In the second embodiment, description has been given of the aspect of correcting the pixel value of the singular pixel by using the pixel values of the pixels surrounding the singular pixel. However, in a case where there are a large number of singular pixels, correction accuracy may decrease.

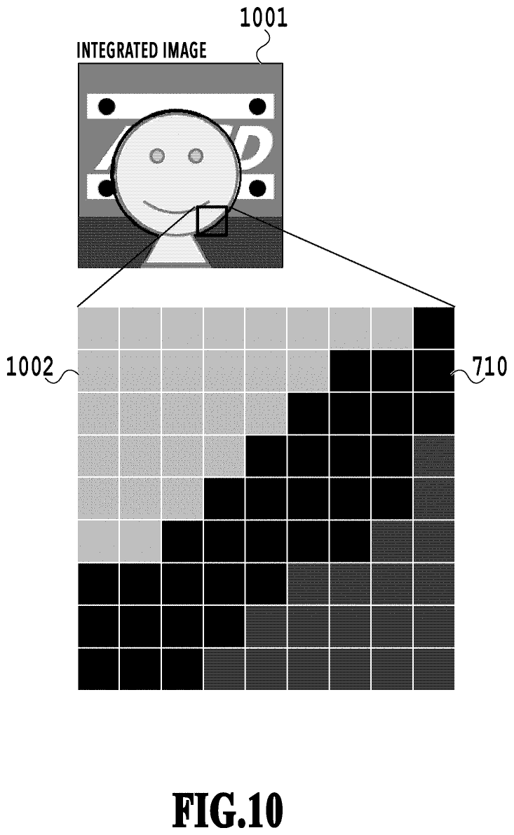

FIG. 10 is a diagram representing a situation in which there are a large number of singular pixels. A boundary part of an integrated image 1001 includes a singular pixel 710. An enlarged image 1002 is a schematic view of the enlarged boundary part. With reference to the enlarged image 1002, it is found that the singular pixels 710 densely exist. In this case, an adjacency set N includes a large number of pixel values of the singular pixels, which makes it difficult to precisely correct the singular pixels by the method of the second embodiment.

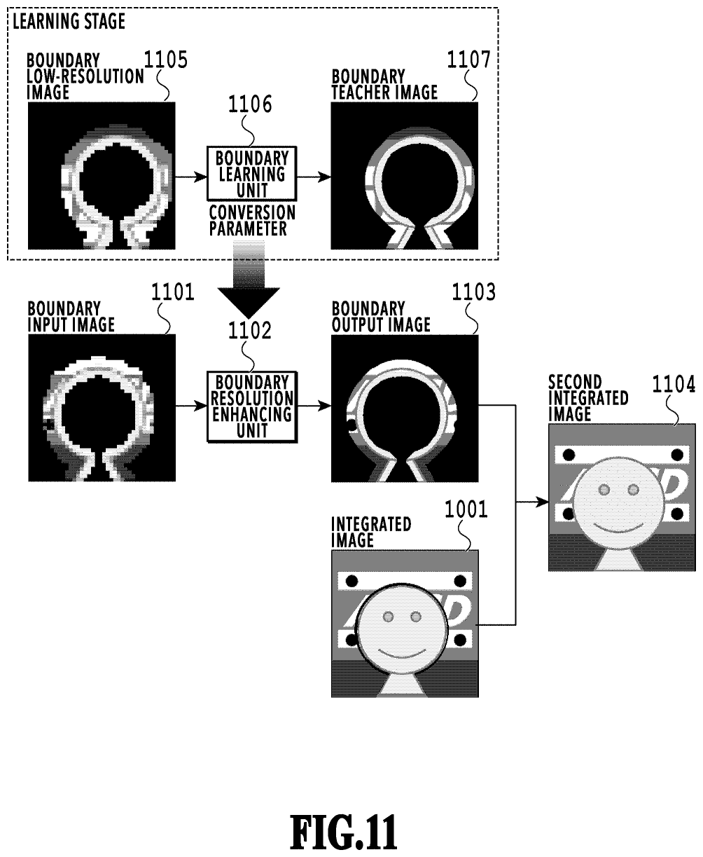

Accordingly, in the present embodiment, an image obtained by extracting an area including a boundary part is resolution-enhanced individually, and the result is superimposed on an integrated image, so as to cope with occurrence of singular pixels. An outline of the present embodiment will be described with reference to FIG. 11.

FIG. 11 is a diagram illustrating an outline of processing according to the present embodiment. It should be noted that the outline of the processing described in the first embodiment will be omitted. In the present embodiment, an image obtained by extracting an area including a boundary part is prepared. This image includes a boundary part between a foreground and a background, and from this image, a pixel at a predetermined distance from the boundary part is extracted as shown in a boundary teacher image 1107. In the learning stage, a set of the boundary teacher image 1107 and a boundary low-resolution image 1105 corresponding to the boundary teacher image 1107 is inputted to a boundary learning unit 1106, and learning is performed. A conversion parameter obtained through learning is outputted to a boundary resolution enhancing unit 1102.

In the application stage, from the low-resolution input image, the image processing apparatus 106 generates a boundary input image 1101 by extracting a portion in the vicinity of the boundary between the foreground and the background. Then, the image processing apparatus 106 inputs the boundary input image 1101 to a neural network (the boundary resolution enhancing unit 1102) that enhances resolution of the boundary part, and obtains a boundary output image 1103 on which resolution enhancing has been performed. The boundary output image 1103 is superimposed on the integrated image 1001 including singular pixels, and a second integrated image 1104 is obtained. This processing allows a pixel value of the singular pixel to be corrected based on information on the boundary output image, not information on the surrounding of the singular pixel. Accordingly, it is possible to obtain an image with a smaller number of artifacts.

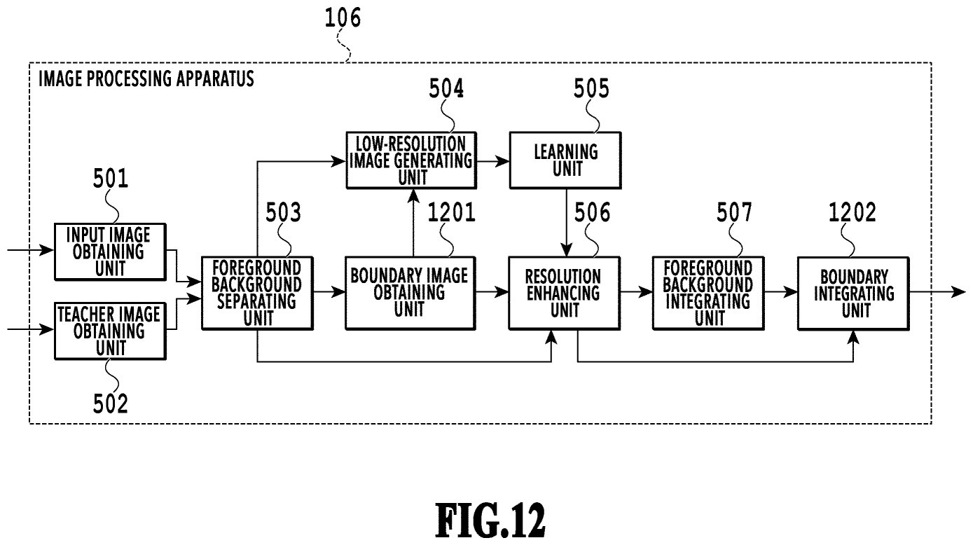

FIG. 12 is a block diagram showing a functional configuration according to the present embodiment. The same component as the one in the first embodiment will be denoted by the same reference numeral, and the description thereof will be omitted. In the present embodiment, the image processing apparatus 106 further includes a boundary image obtaining unit 1201 and a boundary integrating unit 1202.

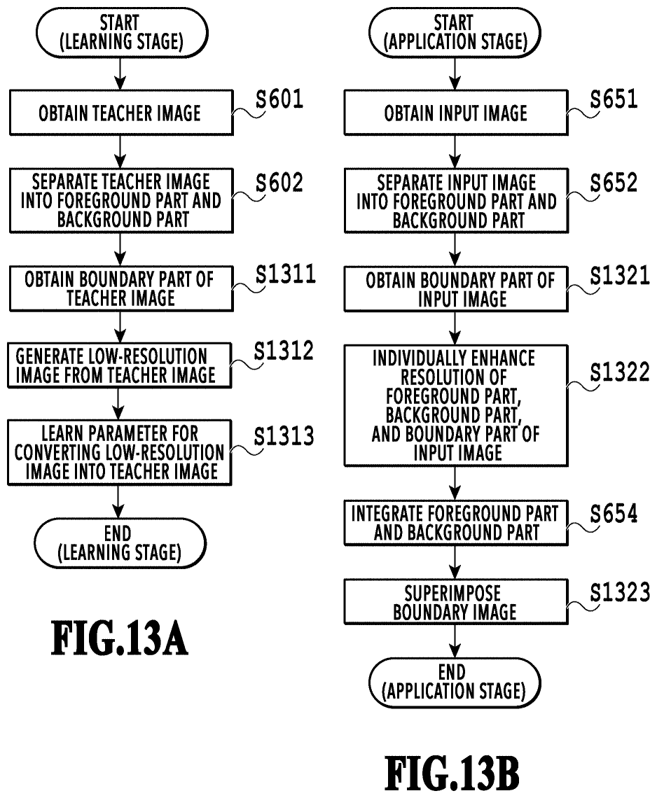

FIG. 13A and FIG. 13B are flowcharts showing an example of processing in the present embodiment. It should be noted that the same processing as the processing in the first embodiment is denoted by the same reference numeral, and the description thereof will be omitted. With reference to FIG. 12, FIG. 13A, and FIG. 13B, the processing in the present embodiment will be described.

FIG. 13A is a diagram showing a processing flowchart in the learning stage. The processing in S601 and S602 in the learning stage is the same as that in the first embodiment. Then in S1311, from the foreground background separating unit 503, the boundary image obtaining unit 1201 obtains an image before separation and generates the boundary teacher image 1107 by extracting the area in the vicinity of the boundary. In the present embodiment, in the boundary teacher image, a value of a pixel having a distance to a boundary pixel being equal to or less than a threshold θ_{border} is the same pixel as that in the image before separation, or otherwise, a pixel becomes a black pixel. It should be noted that an input boundary image as will be described later is defined in the same manner. The boundary pixel is a pixel in a foreground adjacent to a pixel in a background, and vice versa. The boundary pixel is determined by using the image separated by the foreground background separating unit 503. Furthermore, θ_{border} is a parameter specifying a magnitude of a width of the boundary image. In the present embodiment, in a differential image of a mask image generated by the foreground background separating unit 503, a pixel having a pixel value of non-zero is determined to be the boundary pixel. The extracted boundary teacher image is inputted to the low-resolution image generating unit 504.

In S1312, the low-resolution image generating unit 504 performs processing to generate the boundary low-resolution image 1105 by reducing resolution of the boundary teacher image, in addition to the procedure in S603 as described in the first embodiment. The reducing resolution may be the same processing as that described in S603. The boundary low-resolution image and the boundary teacher image are outputted to the learning unit 505.

In S1313, the learning unit 505 learns the received images by using the neural network like S604 described in the first embodiment. In S1313, in addition to the procedure in S604, the following procedure is performed. That is, the boundary low-resolution image is inputted to a boundary neural network (the boundary learning unit 1106); a neural network parameter (a boundary conversion parameter) is adjusted such that the boundary low-resolution image is converted into the boundary teacher image; and a boundary conversion parameter is obtained. The obtained boundary conversion parameter is outputted to the resolution enhancing unit 506. The processing in the learning stage has been described.

Next, the processing in the application stage will be described. FIG. 13B is a diagram showing a processing flowchart in the application stage. The processing in S651 and S652 is the same as that in the first embodiment. Then in S1321, from the foreground background separating unit 503, the boundary image obtaining unit 1201 obtains an input image, and obtains the boundary input image 1101 by extracting the area in the vicinity of the boundary in the same manner as the method in S1311. The obtained boundary input image 1101 is outputted to the resolution enhancing unit 506.

In S1322, the resolution enhancing unit 506 performs resolution enhancing processing on the received image like S653 described in the first embodiment. In the present embodiment, in addition to the procedure in S653, a boundary input image is obtained from the boundary image obtaining unit 1201. Furthermore, the resolution enhancing unit 506 obtains a boundary conversion parameter from the learning unit 505. The resolution enhancing unit 506 substitutes the boundary conversion parameter into a boundary neural network (the boundary resolution enhancing unit 1102) having the same layer structure as the one used in the learning unit 505 and inputs the boundary input image, thereby obtaining the boundary output image 1103 on which resolution enhancing has been performed as its output. The boundary output image is outputted to the boundary integrating unit 1202.

In S1323, the boundary integrating unit 1202 obtains the boundary output image 1103 from the resolution enhancing unit 506. The boundary integrating unit 1202 also obtains the integrated image 1001 from the foreground background integrating unit 507. Then, the boundary integrating unit 1202 generates the second integrated image 1104 by integrating the obtained images in accordance with the following expression (5):

s′_{x,y,c}=α_{x,y}e_{x,y,x}+(1−α_{x,y})s_{x,y,c} Expression (5).

In the expression (5), s′_{x,y,c} indicates a value of a channel c of a pixel in the coordinate position (x, y) in the second integrated image. e_{x,y,c} indicates a value of a channel c of a pixel in the coordinate position (x, y) in the boundary output image. α is a parameter representing a blend ratio between the images in integration and is set to a larger value as a distance to the vicinity of the boundary pixel decreases. More specifically, this is written with the following expression (6):

$${α}_{x , y} = 1 - \frac{{d}_{x , y}}{{θ}_{border}} . \qquad Expression ( 6 )$$

d_{x,y} is a distance to the boundary pixel at the smallest distance as viewed from the coordinates (x, y). That is, a value of α is 1 on the boundary, and becomes closer to 0 as a distance from the boundary increases.

As described above, according to the present embodiment, even in a case where a large number of singular pixels occur in the boundary part, it is possible to inhibit an artifact that may occur in the boundary part.

### Fourth Embodiment

In the first to third embodiments, the foreground input image and the background input image have been used as inputs to the neural network. However, a set of an input image and a mask image may be used instead. In the present embodiment, an aspect of inputting two images to a neural network will be described.

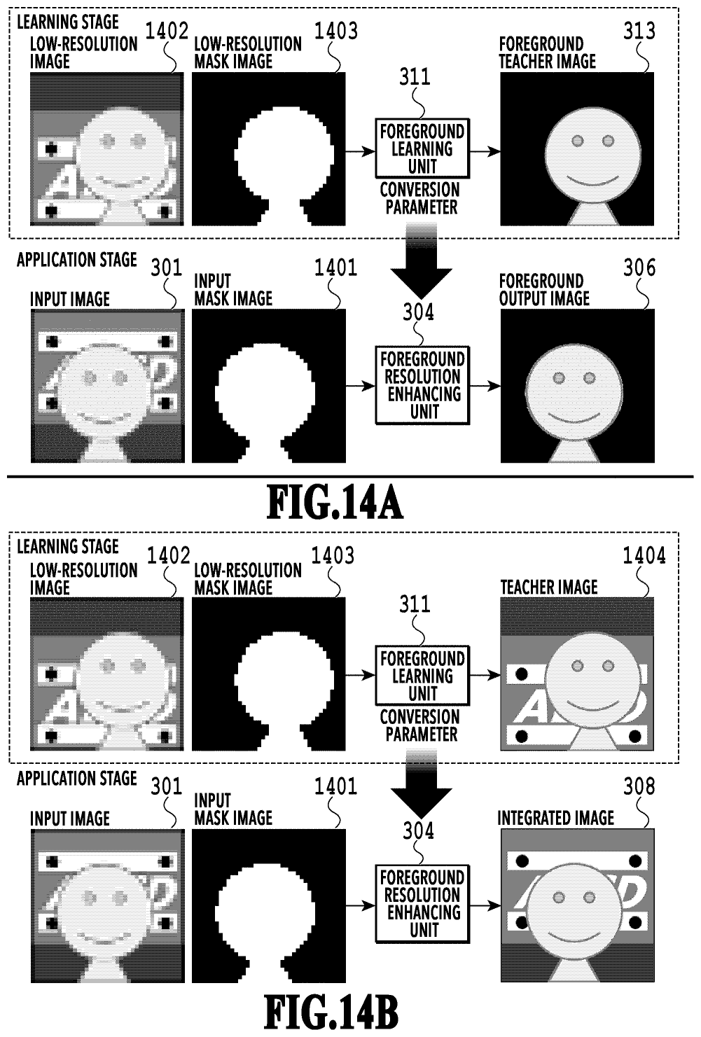

FIG. 14A and FIG. 14B are flowcharts showing an example of processing in the present embodiment. As shown in FIG. 14A, in the application stage, a set of the input image 301 and an input mask image 1401 which is a mask image masking a foreground of the input image 301 is inputted to a foreground neural network (the foreground resolution enhancing unit 304), and the foreground output image 306 is obtained. In this case, the foreground neural network has a 2-input 1-output structure. In the learning stage, the learning unit 505 receives from the low-resolution image generating unit 504 a pair of a low-resolution image 1402 obtained by reducing resolution of a teacher image and a low-resolution mask image 1403 which is a mask image masking a foreground of the low-resolution image 1402. Then, the learning unit 505 learns a foreground conversion parameter for converting the pair into the foreground teacher image 313. The above processing is performed also through a process of obtaining a background output image. In other words, in the application stage, a set of an input image and an input mask image which is a mask image masking a background of the input image is inputted to a background neural network, and a background output image is obtained. In the learning stage, the learning unit 505 receives from the low-resolution image generating unit 504 a pair of a low-resolution image obtained by reducing resolution of a teacher image and a low-resolution mask image which is a mask image masking a background of the low-resolution image. Then, the learning unit 505 learns a background conversion parameter for converting the pair into the background teacher image.

Note that in using a mask image, the learning unit 505 may learn to directly obtain the integrated image 308 by using the neural network. In this case, as shown in FIG. 14B, in the learning stage, the learning unit 505 learns a conversion parameter for converting the set of the low-resolution image 1402 and the low-resolution mask image 1403 into a teacher image 1404. In the application stage, based on the learned parameter, the set of the input image 301 and the input mask image 1401 is inputted to the neural network, and the integrated image 308 is obtained.

It should be noted that an aspect in combination with the aspect described in the second or third embodiment may be used. In other words, it is also possible to employ an aspect of further performing processing of correcting a singular pixel in an image on which resolution enhancing has been performed using a mask image.

### Fifth Embodiment

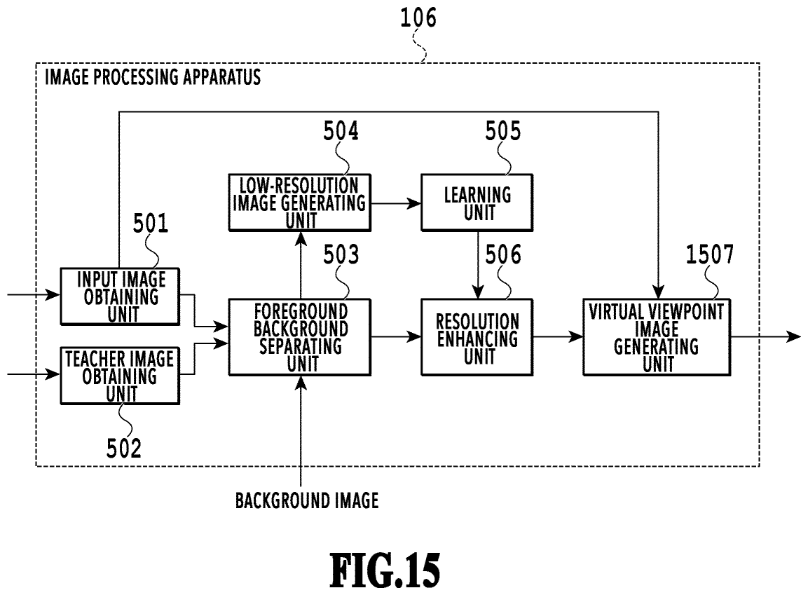

In the present embodiment, description will be given of an aspect of generating a virtual viewpoint image using an image on which resolution enhancing has been performed by the processing described in the first to fourth embodiments. FIG. 15 is a block diagram showing a functional configuration of the image processing apparatus 106 according to the present embodiment. The same component as the one shown in FIG. 5 described in the first embodiment will be denoted by the same reference numeral, and the description thereof will be omitted. The image processing apparatus 106 according to the present embodiment is configured to have a virtual viewpoint image generating unit 1507 instead of the foreground background integrating unit 507 of the configuration of the first embodiment. An input image (an image captured by an image capturing device) obtained by the input image obtaining unit 501 is inputted to the virtual viewpoint image generating unit 1507. It should be noted that although an aspect without the foreground background integrating unit 507 is shown herein, like the configuration shown in FIG. 5 described in the first embodiment, the image processing apparatus 106 may have a foreground background integrating unit, and an image integrated by the foreground background integrating unit may be inputted to the virtual viewpoint image generating unit 1507.

An outline of a virtual viewpoint image will be simply described. There is a technology of generating a virtual viewpoint image from any virtual viewpoint by using multi-viewpoint images captured from multiple viewpoints. For instance, by using a virtual viewpoint image, a highlight scene of soccer or basketball can be viewed and browsed at various angles, so that an enhanced sense of realism can be given to a user as compared to ordinary images.

A virtual viewpoint image based on the multi-viewpoint images may be generated by collecting images captured by multiple cameras into the image processing apparatus 106 on a server or the like and performing rendering processing or the like in the virtual viewpoint image generating unit 1507 of the image processing apparatus 106. Furthermore, the generated virtual viewpoint image is transmitted to a user terminal and browsed in the user terminal.

In generating a virtual viewpoint image, rendering processing is performed after separating a foreground which is a main subject (object) from a background part and modeling the foreground. In modeling the foreground, there are required foreground mask information corresponding to a silhouette of the foreground as viewed from multiple cameras and foreground texture information (for example R, G, B color information of each pixel in the foreground). The modeling of the foreground is performed by performing three-dimensional shape estimation processing on each object existing in an image capturing scene by using the foreground mask and the foreground texture from the multiple viewpoints. To the estimation method, known methods may be applied such as a visual-hull method using outline information on an object or a multi-view stereo method using a triangulation method. Accordingly, data representing three-dimensional shape of the object (e.g., polygon data or voxel data) is generated.

Then, the virtual viewpoint image generating unit 1507 generates a virtual viewpoint image according to a camera parameter of a virtual camera representing a virtual viewpoint or the like. The virtual viewpoint image, that is, an image viewed from a virtual camera, may be generated based on 3D geometric data on the object obtained by the geometric estimation processing with use of a computer graphics technology. To the generating processing, a known technology may be appropriately applied.

The foreground background separation processing described in the above-described embodiment is processing performed in the process of generating a virtual viewpoint image. For this reason, by using the image obtained by resolution enhancing the foreground image and the background image obtained by the processing of generating a virtual viewpoint image, it is possible to generate a virtual viewpoint image with a higher accuracy. In other words, the virtual viewpoint image generating unit 1507 may include the foreground background separating unit 503. Furthermore, in the process of generating a virtual viewpoint image, the processing of generating a virtual viewpoint image may be performed by using an image obtained by resolution enhancing only one of the foreground image and the background image. For instance, in modeling the foreground, the above modeling processing may be performed after resolution enhancing the foreground image. In this case, the foreground image and the background image on which resolution enhancing has been performed in the resolution enhancing unit 506 may not need to be integrated. Moreover, in the resolution enhancing unit 506, only the foreground image may be resolution-enhanced. In generating a virtual viewpoint image, the foreground image on which resolution enhancing has been performed may be used in rendering (coloring processing) the modeled foreground. That is, in generating a virtual viewpoint image, the virtual viewpoint image generating unit 1507 determines a pixel value of the foreground in the virtual viewpoint image by using the foreground image on which resolution enhancing has been performed. Furthermore, in generating a virtual viewpoint image, the virtual viewpoint image generating unit 1507 determines a pixel value of the background in the virtual viewpoint image by using the background image on which resolution enhancing has been performed.

It should be noted that in the present embodiment, the example of the configuration that the image processing apparatus 106 has the virtual viewpoint image generating unit 1507 has been described, but a virtual viewpoint image may be generated by a virtual viewpoint image generating device that is different from the image processing apparatus 106. That is, the image processing apparatus 106 as shown in FIG. 15 may be provided for each image capturing device; an image on which resolution enhancing has been performed by each of the image processing apparatuses 106 may be outputted to a virtual viewpoint image generating device; and a virtual viewpoint image may be generated by the virtual viewpoint image generating device. In this case, at least one of an image obtained by resolution enhancing only the foreground image and an image obtained by resolution enhancing only the background image may be outputted to the virtual viewpoint image generating device, or an integrated image obtained by integrating the images may be outputted.

### Other Embodiments

In the above-described embodiments, the example of the aspect of resolution enhancing the image has been shown, but the processing described in the above embodiments may be applied to typical image processing. For example, in performing image recognition based on learning or in performing image conversion such as noise reduction, blur reduction, or texture conversion, an image may be separated into a foreground and a background and learning may be performed.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to the present disclosure, it is possible to enhance a resolution of an image while inhibiting occurrence of blurs or artifacts.

This application claims the benefit of Japanese Patent Application No. 2019-021687, filed Feb. 8, 2019, which is hereby incorporated by reference wherein in its entirety.

What is claimed is:

1. An image processing apparatus comprising:
an obtaining unit configured to obtain a first input image including a first area representing a specific object in a captured image obtained by capturing by an image capturing device; and
an outputting unit configured to output a first output image having a higher resolution as compared to the first input image by inputting the first input image obtained by the obtaining unit, the first output image being used to generate a virtual viewpoint image.

2. The image processing apparatus according to claim 1, wherein the obtaining unit further obtains a second input image including a second area different from the first area in the captured image, and
wherein the outputting unit outputs a second output image having a higher resolution as compared to the second input image by inputting the second input image obtained by the obtaining unit, the second output image being used to generate a virtual viewpoint image.

3. The image processing apparatus according to claim 1, wherein the outputting unit outputs the first output image and the captured image to a generating unit configured to generate a virtual viewpoint image.

4. The image processing apparatus according to claim 1, wherein the outputting unit outputs, from the first input image, the first output image based on a learning result using a first teacher image including an area including a specific object and a first image having a lower resolution as compared to the first teacher image, the first image being an image corresponding to the first teacher image.

5. The image processing apparatus according to claim 2, wherein the outputting unit outputs, from the second input image, the second output image based on a learning result using a second teacher image including an area different from an area including a specific object and a second image having a lower resolution as compared to the second teacher image, the second image being an image corresponding to the second teacher image.

6. The image processing apparatus according to claim 2, further comprising an integrating unit configured to integrate the first output image and the second output image outputted by the outputting unit.

7. The image processing apparatus according to claim 6, further comprising a correcting unit configured to correct a value of a pixel in a boundary part between the first area and the second area in an integrated image integrated by the integrating unit.

8. The image processing apparatus according to claim 7, wherein the correcting unit corrects, among values of pixels in the boundary part, a pixel value having a difference equal to or greater than a threshold from a value of a surrounding pixel.

9. The image processing apparatus according to claim 8, wherein the correcting unit corrects the pixel value having a difference equal to or greater than a threshold by using a value of a pixel adjacent the boundary part.

10. The image processing apparatus according to claim 8, wherein the correcting unit performs the correction by replacing the pixel value having a difference equal to or greater than a threshold with any one of a median, an average, and a most frequent value of a pixel adjacent the boundary part.

11. The image processing apparatus according to claim 1, wherein the outputting unit includes a neural network.

12. The image processing apparatus according to claim 1, further comprising a generating unit configured to generate three-dimensional shape data on an object based on the first output image.

13. The image processing apparatus according to claim 1, wherein the first output image is used to determine a pixel value of a specific object in a virtual viewpoint image.

14. The image processing apparatus according to claim 3, wherein the generating unit determines a pixel value of a specific object in a virtual viewpoint image by using the first output image.

15. An image processing method comprising the steps of:
obtaining a first input image including a first area representing a specific object in a captured image obtained by capturing by an image capturing device; and
outputting a first output image having a higher resolution as compared to the first input image by inputting the first input image obtained in the obtaining step, the first output image being used to generate a virtual viewpoint image.

16. A non-transitory computer readable storage medium storing a program which causes a computer to perform an image processing method, the method comprising the steps of:
obtaining a first input image including a first area representing a specific object in a captured image obtained by capturing by an image capturing device; and
outputting a first output image having a higher resolution as compared to the first input image by inputting the first input image obtained in the obtaining step, the first output image being used to generate a virtual viewpoint image.
